(19) United States
(12) Patent Application Publication
(10) Pub. No.: US 2006/0190882 A1
(43) Pub. Date: Aug. 24, 2006

(54) System and method for generating assertions using waveforms

(75) Inventors: David Fong, San Jose, CA (US); Zheng (Joy) Zhang, Shanghai (CN); Qi (Christine) Chen, Shanghai (CN)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: VIA Technologies, Inc

(21) Appl. No.: 11/050,212

(22) Filed: Feb. 3, 2005

(51) Int. Cl. G06F 17/50

(52) U.S. Cl. 716/6

(57) ABSTRACT

Systems and methods for generating a Hardware Design Language (HDL) assertion from a waveform diagram are disclosed. One method comprises: identifying a timing relationship between first and second signals in the diagram; and generating an HDL assertion corresponding to the relationship. The relationship comprises a portion of the first signal, a portion of the second signal, and an interval between the portions. Another method comprises: identifying a combinatorial relationship between two input signals and an output signal in the diagram; and generating an HDL assertion corresponding to the relationship. One system comprises logic for performing the steps of: receiving a plurality of signal descriptions, each describing one of a plurality of signals; receiving a description of a timing or combinatorial relationship between at least two of the plurality of signals; generating a waveform diagram including a representation of the relationship; and generating an HDL assertion corresponding to the relationship.

### FIELD OF THE INVENTION

The present invention relates to software tools for designing digital integrated circuits, and more specifically, to a system or method for generating hardware design language assertions from waveform diagrams.

### BACKGROUND

Designers of digital integrated circuits (ICs) use various software tools to design an IC. The design engineer writes code in a Hardware Design Language (HDL), also known as a Register Transfer Language (RTL). The IC designer then runs a simulator which tests the design using the HDL code as input. After fixing any problems found in the code by the simulation process, the HDL code is then used as input by a synthesizer. The synthesizer translates the HDL code into a physical representation of an IC, which can then be produced as a physical IC in the form of an Field Programmable Gate Array (FPGA), Application-Specific Integrated Circuit (ASIC), or custom silicon IC.

During the simulation process, a verification engineer instruments the HDL code with assertions to verify that the HDL code is an accurate implementation of the intended design. An assertion is a statement that expresses how a particular design feature should or should not behave. For example, the code for a particular logic block may assume that only one of two input signals is active at any one time. As another example, a logic block may assume that an input will never be larger than a certain maximum value. As yet another example, a logic block may assume that a request signal will remain asserted until after an acknowledge signal is asserted. Each of these assumptions made by the designer can be expressed as assertion.

Assertions may be written in a variety of languages. Some HDL languages provide native support for assertions, for example, VHDL and SystemVerilog. Languages have also been developed specifically to express assertions, for example, Vera, Jeda, e, and Property Specification Language (PSL).

Using existing tools and methods, a verification or design engineer must infer timing relationships from waveform diagrams, and write assertions such to express the relationships. This is a time-consuming and error-prone process because it is a manual, rather than an automated, process. In addition, a verification or design engineer may be required to learn several different assertion languages (e.g., SystemVerilog, Vera, e, PSL, etc.), because different development tools support different languages. Therefore, a better method for generating assertions is needed.

### SUMMARY

Systems and methods for generating a Hardware Design Language (HDL) assertion from a waveform diagram are disclosed. One method comprises: identifying a timing relationship between first and second signals in the diagram; and generating an HDL assertion corresponding to the relationship. The relationship comprises a portion of the first signal, a portion of the second signal, and an interval between the portions. Another method comprises: identifying a combinatorial relationship between two input signals and an output signal in the diagram; and generating an HDL assertion corresponding to the relationship. One system comprises logic for performing the steps of: receiving a plurality of signal descriptions, each describing one of a plurality of signals; receiving a description of a timing or combinatorial relationship between at least two of the plurality of signals; generating a waveform diagram including a representation of the relationship; and generating an HDL assertion corresponding to the relationship.

### DESCRIPTION OF THE DRAWINGS

Many aspects of the invention can be better understood with reference to the following drawings. The components in the drawings are not necessarily to scale, emphasis instead being placed upon clearly illustrating the principles of the present invention.

FIG. 1 shows the use of a timing relationship symbol in a waveform diagram to define a timing relationship.

FIG. 2 shows another example of the use of a timing relationship symbol in a waveform diagram.

FIG. 3 shows yet another example of the use of an timing relationship symbol in a waveform diagram.

FIG. 4 shows a waveform diagram and the assertion(s) generated through analysis of the diagram.

FIG. 5 is a diagram of an example user interface for the method for generating assertions using waveforms.

FIG. 6 illustrates the process of defining signals and generating waveforms for those signals.

FIG. 7 illustrates the process of defining a timing relationship between signals, and representing these relationships on the generated waveform.

FIG. 8 illustrates defining additional timing relationships.

FIG. 9 illustrates an assertion produced from the waveform and timing relationships.

FIG. 10 illustrates the process of defining input signals and generating waveforms for those signals.

FIG. 11 illustrates the process of defining an output signal and generating a waveform for that signal.

FIG. 12 illustrates the process of defining a logical, or combinatorial, relationship between signals.

FIG. 13 illustrates the process of defining an additional combinatorial relationship.

FIG. 14 illustrates an assertion produced from the waveform and combinatorial relationships.

FIG. 15 illustrates another embodiment allowing a combination of timing and combinatorial relationships to be defined.

FIG. 16 is a flow chart of the method for generating assertions using waveforms.

FIG. 17 is a block diagram of a general-purpose computer system that can be used to implement an embodiment of the method for generating assertions using waveforms.

### DETAILED DESCRIPTION

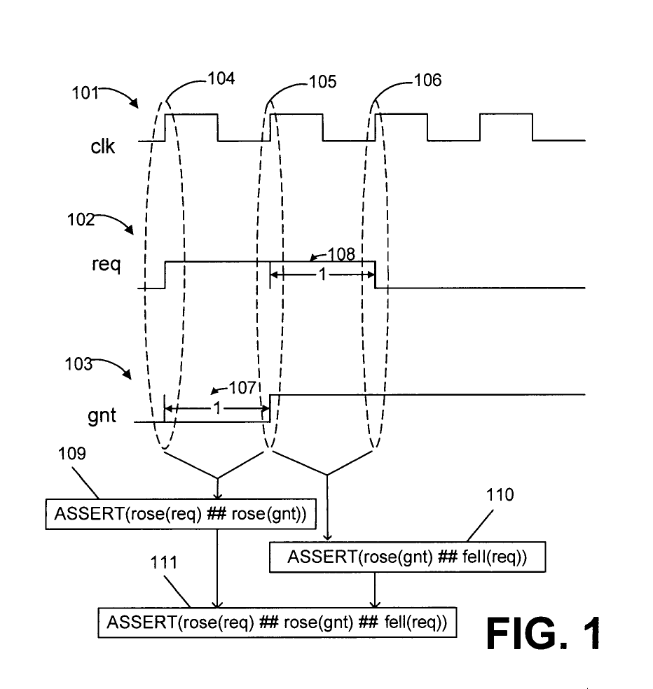

FIG. 1 shows the use of a timing relationship symbol in a waveform diagram to define a timing relationship. The waveform diagram may be generated by the method for generating assertions using waveforms, or the method may operate on a diagram that was generated by some other means or program. The waveform diagram includes a clock 101, a signal req 102, and a signal gnt 103. The rising edge of the first clock is coincident with a transition from low to high on the req signal (104), the rising edge of the second clock is coincident with a transition from low to high on the gnt signal (105), and the rising edge of the third clock is coincident with a transition from high to low on the req signal (106).

One skilled in the art will realize that several timing relationships between signal req 102 and signal gnt 103 are implied by the diagram. In natural language, one of the relationships is expressed as “req goes high and gnt goes high one clock period later.” In a timing relationship, the action of one signal (the “follower”) is dependent on the action of another signal (the “antecedent”). Here, req is the antecedent and gnt is the follower.

The presence of this first timing relationship is explicitly indicated in the diagram with timing relationship indicator 107. In one embodiment, the timing relationship indicator 107 is generated by the method based on user input. In another embodiment, the method operates on timing relationship indicators that are generated by some other means or program.

Timing relationship indicator 107 defines the relationship as follows. One edge of indicator 107 is aligned with the portion (104) of the antecedent signal that transitions from low to high, while the other edge is aligned with the portion (105) of the follower signal that transitions from low to high. The indicator 107 spans the two signal portions, or segments, that describe the timing relationship. The indicator 107 also includes an indication of the number of clock periods that are allowed to occur between the two signal transitions. In some embodiments, the number of cycles may be a range, for example, 1-4.

A second timing relationship between signal req 102 and signal gnt 103 (“req goes low one clock period after gnt goes high”) is also implied by the diagram and explicitly indicated with another timing relationship indicator (108). In this second relationship, gnt is the antecedent and req is the follower. One edge of indicator 108 is aligned with the portion (105) of the antecedent that transitions from low to high, and the other edge is aligned with the portion 106 of the follower that transitions from high to low. The timing relationship indicator 107 in FIG. 1 is only one example of a graphical symbol that can be used to define a timing relationship. Any user input (either graphical or text) that allows a user to specify a portion of the antecedent, a portion of the follower, and the interval in between can be used.

The timing relationship expressed by the indicators are mapped by the method to assertions: the relationship defined by indicator 107 is mapped to assertion 109; and the relationship defined by indicator 108 is mapped to assertion 110. Each assertion expresses the timing relationship as a condition that must hold true. The assertions generated by the method can then be used by the engineer during simulation or formal verification, where a violation of an assertion is typically recorded and flagged as an error. One skilled in the art will understand the use of assertions to express timing relationships without further explanation. One skilled in the art will also understand that the method can support many different assertion languages. Furthermore, one embodiment may simultaneously support multiple languages, with the user selecting which language is currently in use.

In one embodiment, multiple timing relationships are combined into a single assertion when the timing relationships are sequential in time. The relationship between transitions 104 and 105 and the relationship between transitions 105 and 106 are sequential: they share a common clock transition 105. The combination of these two sequential timing relationships can be expressed by the single assertion 111. In some embodiments, the user can override this behavior of combining sequential relationships into a single assertion, and the override can occur on a per-relationship basis.

Indicator 107 defines a timing relationship between a transition on the antecedent and a transition on the follower. Therefore, assertion 109 also expresses a timing relationship using two signal transitions. In this example, the method generates assertions in the SystemVerilog language. Therefore, the SystemVerilog keyword rose is used in assertion 109 to express the timing relationship using signal transitions: rose (req) # # rose (gnt). When using other assertion languages, the method uses signal transition keywords appropriate to the chosen language.

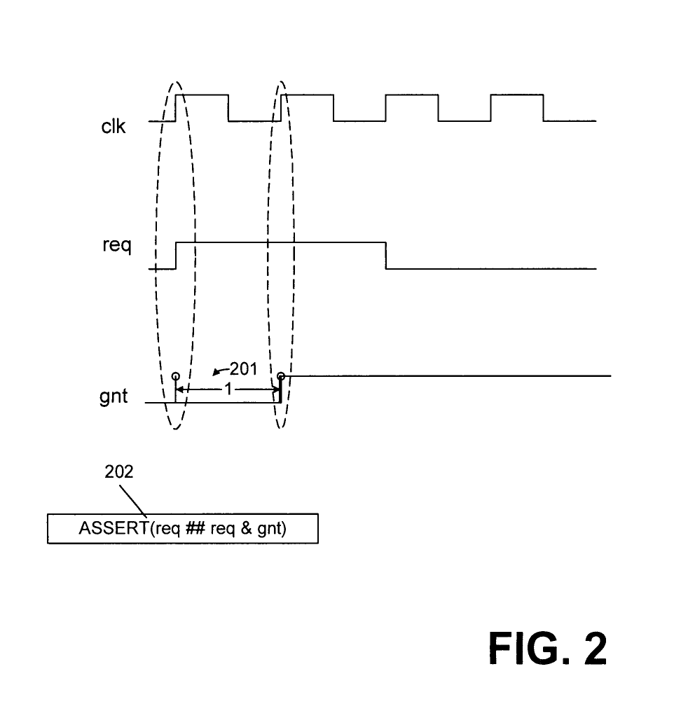

Another embodiment of the method for generating assertions using waveforms, shown in FIG. 2, allows the definition of timing relationships that use signal states instead of signal transitions. The waveform diagram includes the same three signals shown in FIG. 1: clock 101, signal req 102, and signal gnt 103. However, a different type of timing relationship indicator 201 is used to define the relationship. The visual appearance of the edges of indicator 201 is different, indicating that the state of the signal, rather than the signal transition, is used to define the relationship. This relationship is expressed in natural language as: “req is high and gnt and req are high one clock period later.” The assertion 202 produced by the method for FIG. 2 (using SystemVerilog) expresses the timing relationship in terms of signal values or states rather than signal transitions. In SystemVerilog, then, assertion 202 is req ## req && gnt, without the signal transition keyword rose.

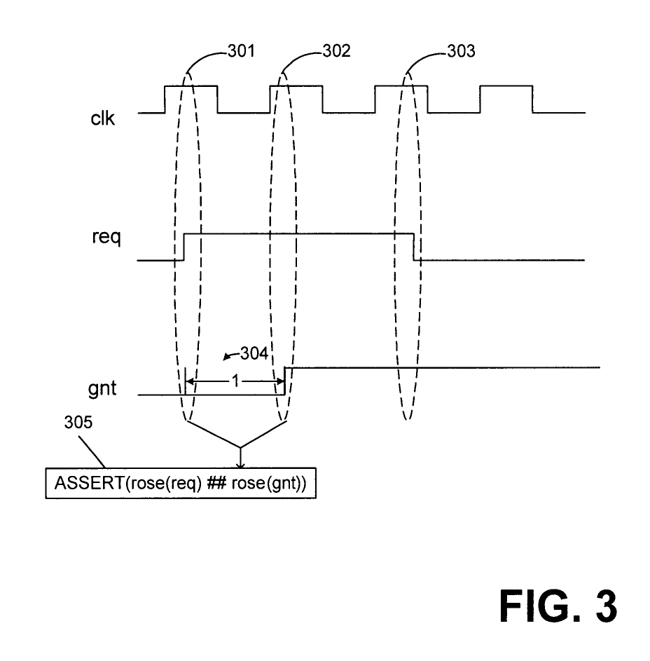

FIG. 3 shows another example of an indicator define a timing relationship in a waveform timing diagram. Here, the signal transitions do not occur on a clock edge, but within a clock period: a low to high transition (301) on the req signal occurs during the first clock period; a low to high transition (302) on the gnt signal occurs during the second clock period; and a high to low transition (303) on the req signal occurs during the during the third clock period. The use of timing relationship indicator 304 in this example is similar to FIG. 1: one edge of the indicator 304 is aligned with the portion (301) of gnt that transitions from low to high, and the other edge is aligned with the portion (302) of req that transitions from high to low. The assertion 305 produced by the method for FIG. 3 is the same as for FIG. 1.

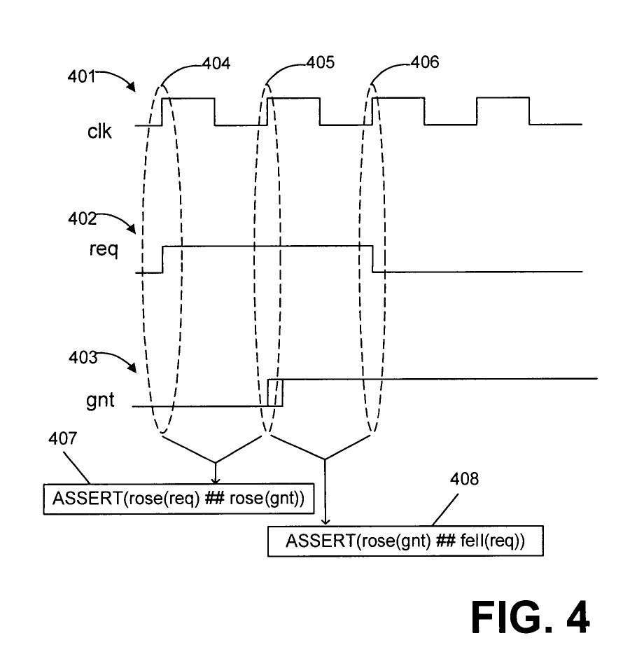

FIG. 4 shows a waveform diagram and the assertion(s) generated, through analysis of the diagram, by the method for generating assertions using waveforms. The waveform diagram includes a clock 401, a signal req 402, and a signal gnt 403. The rising edge of the first clock is coincident with a transition from low to high on the req signal (404), the rising edge of the second clock is coincident with a transition from low to high on the gnt signal (405), and the rising edge of the third clock is coincident with a transition from high to low on the req signal (406).

The diagram of FIG. 4 does not explicitly depict a timing relationship between req and gnt. However, in this embodiment, the method identifies the existence of one or more timing relationships from a clocked waveform diagram, by analyzing signal transitions that occur on clock edges. The method identifies one timing relationship from transitions 404 and 405: gnt goes high one clock period after req goes high. The method identifies another timing relationship from transitions 405 and 406: req goes low one clock period after gnt goes high. Since engineers are familiar with extracting timing relationships from waveform diagrams, one skilled in the art will understand how such timing relationships can be inferred without further explanation.

The method generates assertions corresponding to the identified timing relationships: the relationship corresponding to transitions 404 and 405 is mapped to assertion 407; and the relationship corresponding to transitions 405 and 406 is mapped to assertion 408. Each assertion expresses the timing relationship as a condition that must hold true.

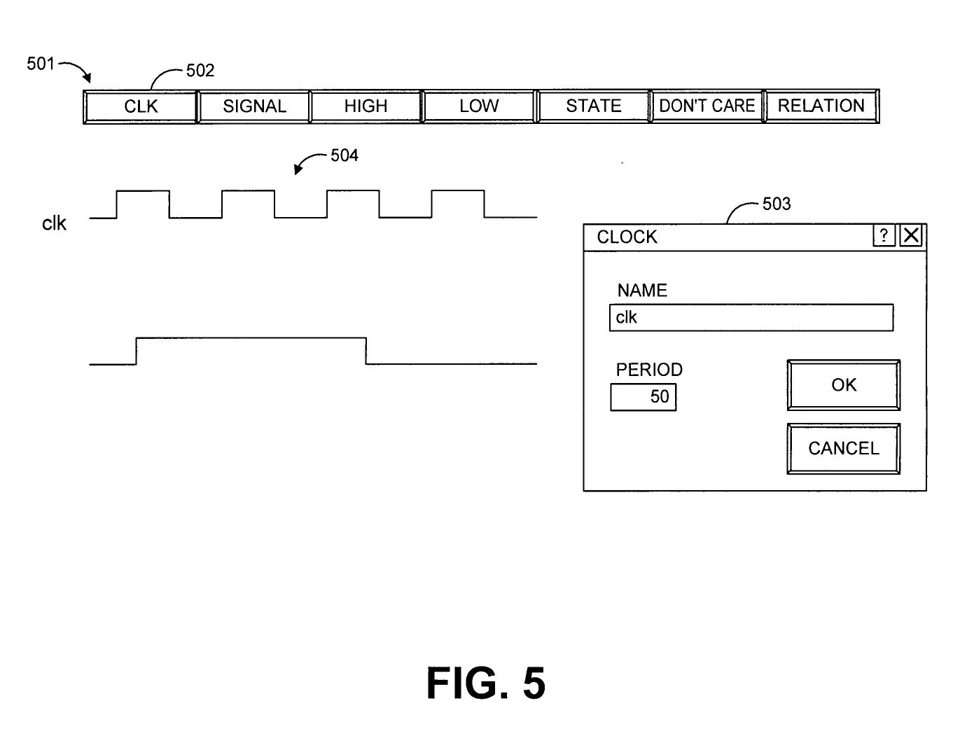

FIG. 5 is a diagram of an example user interface for the method for generating assertions using waveforms. Through an interactive process, the user enters descriptions of signals and relationships between them, and the program generates a waveform diagram based on the user's input. The user can view this diagram and then edit the signals and relationships, so that a new waveform diagram is produced. The user interface includes commonly-known controls (e.g., pushbuttons, dropdown lists, text entry fields) as well as custom controls to draw the signals and to enter relationships.

The user defines signals and relationships using a group of buttons 501, using the sequences of user interactions shown in FIGS. 5-8. FIG. 5 illustrates defining a clock signal. When the CLK button 502 is activated, a clock signal description dialog 503 appears. Though this dialog 503, the user enters the clock signal name and the clock period. When the dialog 503 is dismissed, the program generates and draws waveform 504 corresponding to the clock signal with the desired period, and labels the waveform with the desired name.

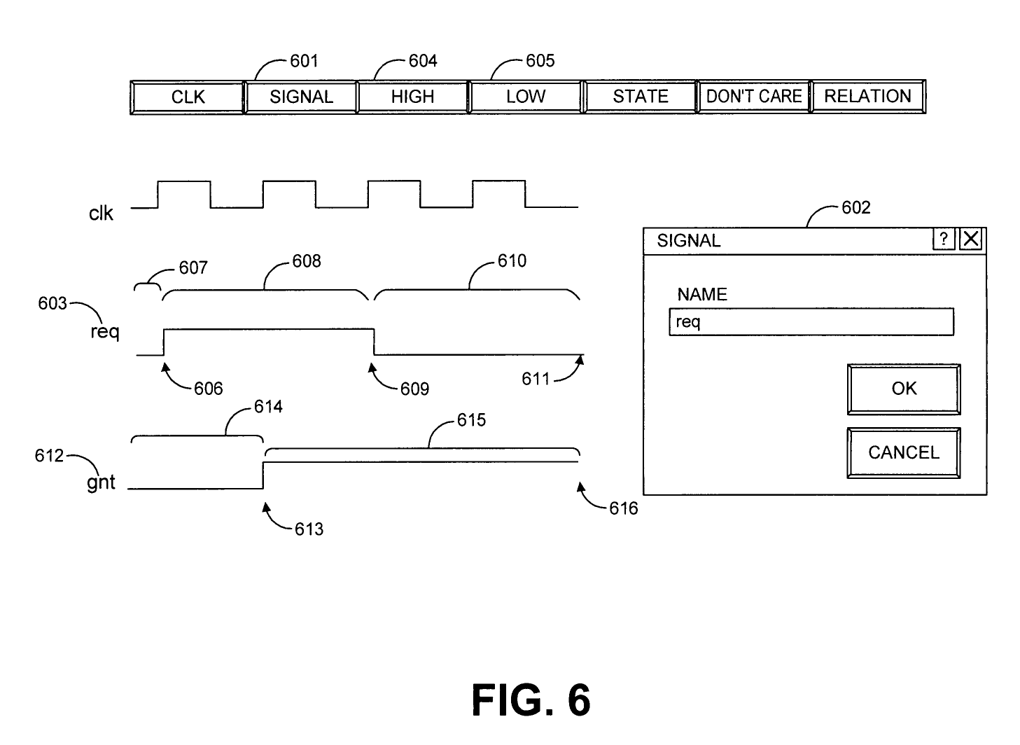

FIG. 6 illustrates the process of defining signals and generating waveforms for those signals. To define a signal, the SIGNAL button 601 is activated, and a signal description dialog 602 appears. Though this dialog 602, the user enters the first signal name (req) and its initial value (High). When the signal description dialog 602 is dismissed, the program generates a signal label 603. To draw the waveform for this req signal, the user activates one of the signal state buttons (HIGH 604 or LOW 605), and then clicks at a point to the right of the label 603. The example signal req goes high in the first clock period and goes low two clocks later. To draw this waveform, the user activates the LOW button 605 and clicks at point 606. The program then generates an initial waveform segment 607 that is low from the start to point 606. The next segment 608 is generated by activating the HIGH button 604 then clicking at point 609. The final segment 610 is generated by activating the LOW button 605 then clicking at point 611.

The second signal, gnt, is defined in a similar manner. The example signal gnt goes high in the second clock period and stays high. To draw the waveform for this gnt signal, the SIGNAL button 601 is activated, and the signal name (gnt) is entered in the signal description dialog 602. When the signal description dialog 602 is dismissed, the program generates a signal label 612. The user then activates the LOW button 605 and clicks at point 613, which results in initial waveform segment 614 that is low from the start to point 613. The second segment 615 is generated by activating the HIGH button 604 then clicking at point 616.

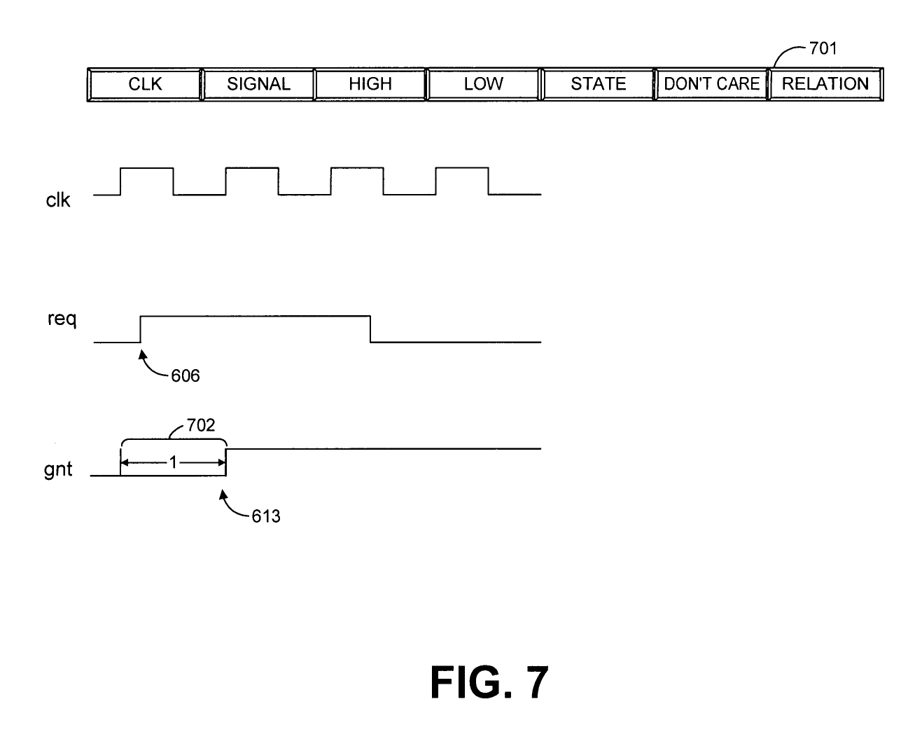

FIG. 7 illustrates the process of defining a timing relationship between signals, and representing these relationships on the generated waveforms. The simplest timing relationship involves two signals: an antecedent signal and a follower signal whose behavior “follows” the antecedent in some way. Using same example discussed earlier and illustrated in FIGS. 5 and 6, gnt goes high one clock period after req goes high, so req is the antecedent and gnt is the follower in this particular relationship.

To define this relationship, the RELATION button 701 is activated. The program creates a timing relationship indicator 702 consisting of a bracket with two edges and a number within the bracket. The user first positions timing relationship indicator 702 along the base of the gnt signal waveform. The user then drags the left edge of timing relationship indicator 702 to align with point 606, where req transitions from low to high, and drags the right edge of timing relationship indicator 702 to align with point 613, where gnt transitions from low to high. The number inside the bracket of timing relationship indicator 702 represents the number of clock periods allowed for the transition, which in this example is 1.

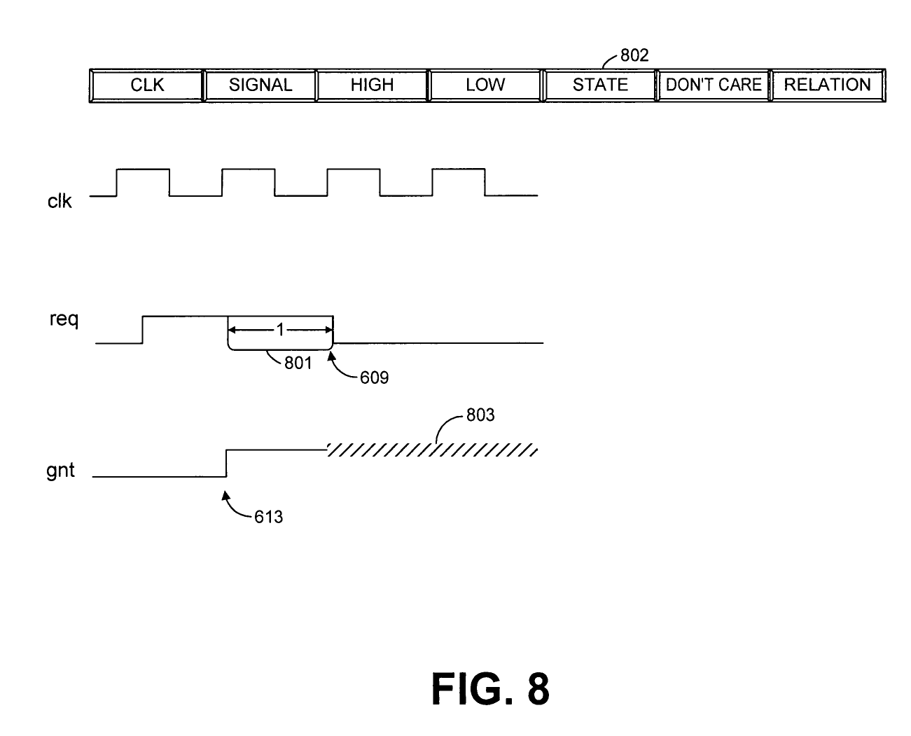

FIG. 8 illustrates defining two more relationships between the signals gnt and req. As defined earlier, the example signal req goes low one clock period after gnt goes high. To define this second relationship, the RELATION button 701 is activated again, which creates another timing relationship indicator 801. The user positions timing relationship indicator 801 along the base of the req signal waveform. Next, the user drags the left edge of timing relationship indicator 801 to align with point 613, where gnt transitions from low to high, and drags the right edge of timing relationship indicator 801 to align with point 609, where req transitions from high to low. The number inside the bracket of timing relationship indicator 801 represents the number of clock periods allowed for the transition, which in this example is 1.

The third relationship to be defined is “the value of gnt after the transition of req to low is a don't care.” This third relationship is defined by activating the DON'T CARE button 802, which produces a block 803. The user positions block 803 along the gnt signal waveform, then drags the left and right edges of block 803 to define the time span for which the value is a don't care. In FIG. 8, the left edge of block 803 is aligned with point 609, where req transitions from high to low, and the right edge of block 803 are aligned with the last clock period.

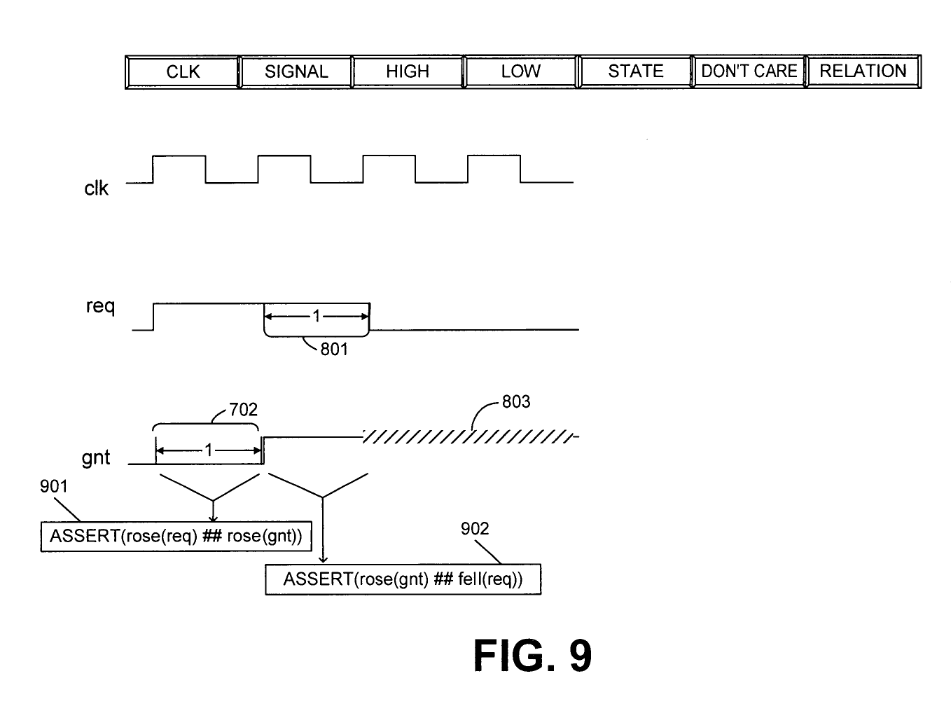

After one or more timing relationships are created using the procedure illustrated in FIGS. 5-8, the user instructs the program to map the relationships in the diagram to assertions. (The mapping process was described earlier in connection with FIGS. 1-4). The result is shown in FIG. 9. The method produces assertion 901 from the information provided by timing relationship indicator 702, and assertion 902 from the information provided by timing relationship indicator 801. In one embodiment, the assertion mapping instruction is given via a menu item (not shown). In another embodiment, the assertion mapping instruction is given via a pushbutton (not shown). In one embodiment, the user specifies a default assertion language through a dialog box, and the default can be overridden via a specific language selection at the time the mapping instruction is given. In another embodiment, the user must specify a specific assertion language when giving the mapping instruction.

Now that the process of capturing a timing relationship between two or more signals has been described in detail, one skilled in the art will understand how to map between the captured timing relationships and assertions in a particular language. Therefore, only a few example mappings will be given here. One skilled in the art will realize also that a single timing relationship can sometimes be expressed in a given language by more than one assertion, so the mapping between timing relationship and assertion is not necessarily one-to-one.

The three timing relationships illustrated in FIGS. 5-8 can be mapped to the following assertions in the SystemVerilog language:

timing relationship indicator 702==>(req ## req && gnt)

timing relationship indicator 801==>(req && gnt ## !req)

The three timing relationships illustrated in FIGS. 3-6 can be mapped to the following PSL assertions:

timing relationship indicator 702==>(req; req & & gnt)

timing relationship indicator 801==>(req && gnt ; req)

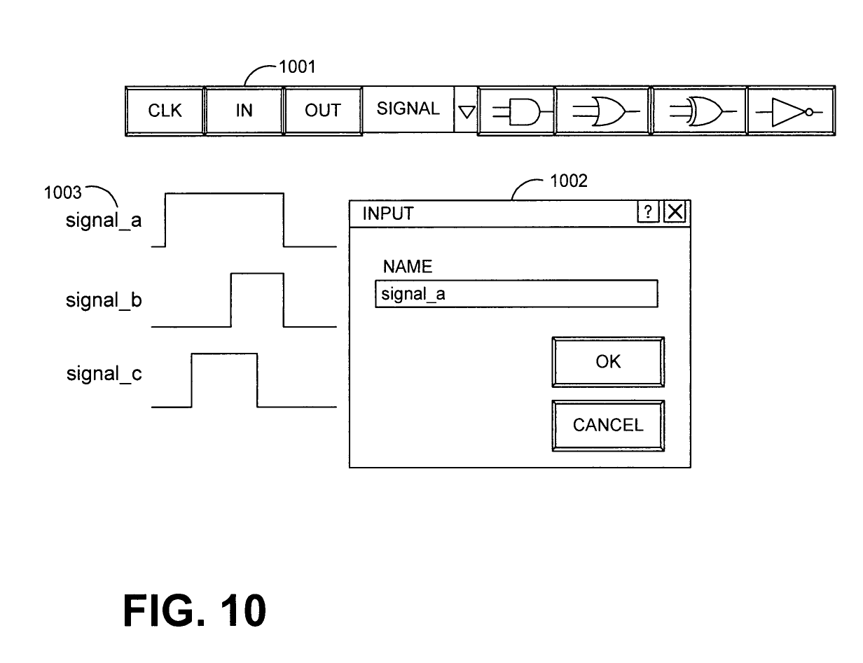

FIGS. 10-14 illustrate the process of defining a logical, or combinatorial, relationship between input and output signals, and representing those relationships in conjunction with a waveform diagram. FIG. 10 illustrates the process of defining input signals and generating waveforms for those signals. To define an input signal, the IN button 1001 is activated, and an input signal description dialog 1002 appears. Though this dialog 1002, the user enters the input signal name (signal_a). When the dialog 1002 is dismissed, the program generates a signal label 1003. The process of drawing the waveform for signal_a is not shown in this example. A user interface like the one in FIG. 5 can be used, or any other kind of interface that results in a waveform being generated for signal_a. Two more input signals, signal_b and signal_c, are generated in a similar manner.

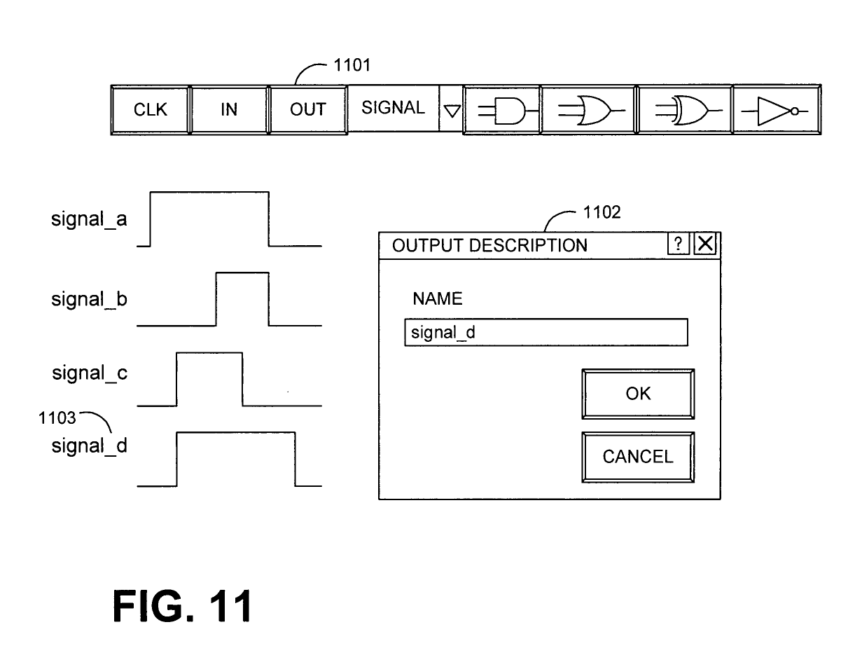

FIG. 11 illustrates the process of defining an output signal and generating a waveform for that signal. To define an output signal, the OUPUT button 1101 is activated, and an output signal description dialog 1102 appears. Though this dialog 1102, the user enters the output signal name (signal_d). When the signal description dialog 1002 is dismissed, the program generates a signal label 1103. The process of drawing the waveform for signal_d is not shown in this example. A user interface like the one in FIG. 5 can be used, or any other kind of interface that results in a waveform being generated for signal_d.

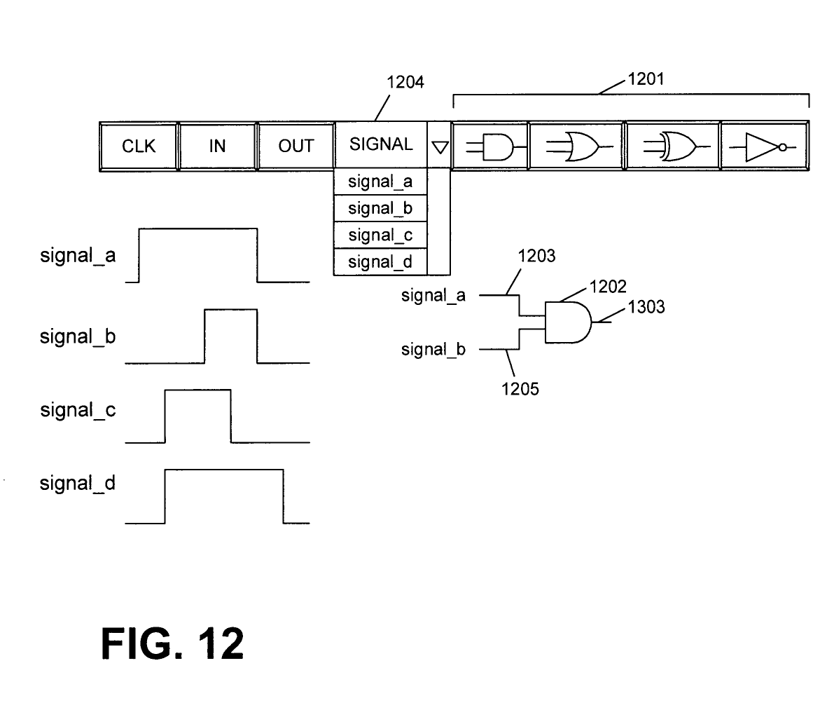

FIG. 12 illustrates the process of defining a logical, or combinatorial, relationship between signals. In one embodiment, the method for generating assertions using waveforms is used to generate the waveform diagram and to define the relationship. In another embodiment, the method operates on a waveform diagram that was generated by some other means or program.

To define a logical relationship, a logical operator is selected using one of the logical operator pushbuttons 1201. In this example, the AND operator is chosen and the method generates an AND relationship symbol 1202. A node for signal_a (1203) is created by selecting signal_a from the SIGNAL list control 1204. Similarly, a node for signal_b (1205) is created by selecting signal_b from the SIGNAL list control 1204. The nodes are connected (e.g., by a dragging motion) to the two inputs of the AND relationship symbol 1202. An “AND” relationship between signal_a and signal_b is thus defined.

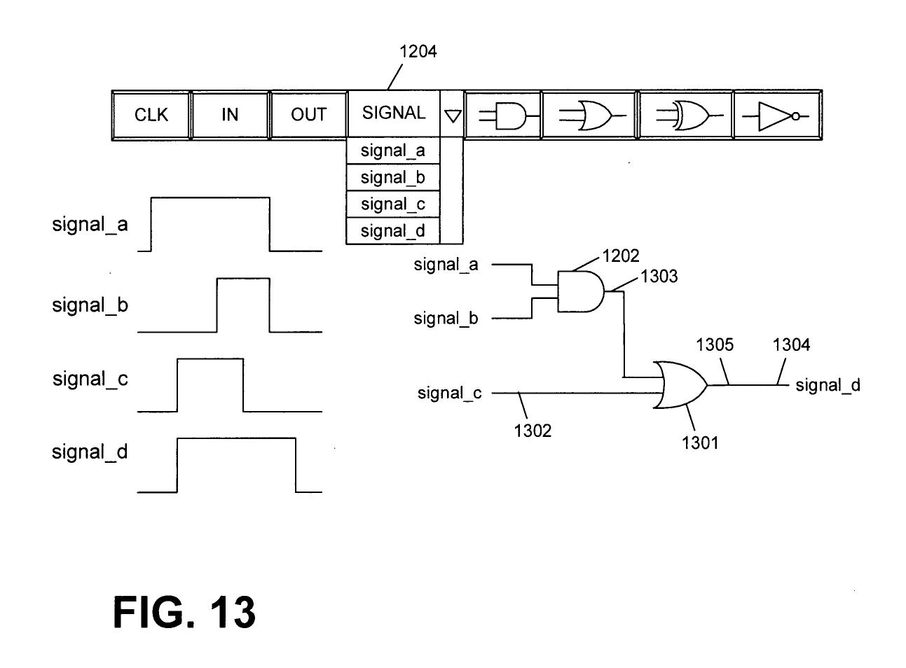

A second combinatorial relationship is defined in FIG. 13. The OR operator is chosen and the method generates an OR relationship symbol 1301. A node for signal_c (1302) is created by selecting signal_c from the SIGNAL list control 1204, and is connected to the OR relationship symbol 1301. Next, the output node (1303) of the AND relationship symbol 1202 is selected, then connected (e.g., by a dragging motion) to the OR relationship symbol 1301. Thus, an “OR” relationship between AND (signal, signal_b) and signal_c is defined. Finally, a node for signal_d (1304) is created by selecting signal_d SIGNAL list control 1204, and is connected to the output node (1305) of the OR relationship symbol 1301. This process defines the combinatorial relationship signal_d=signal_a & signal_b OR|signal_c.

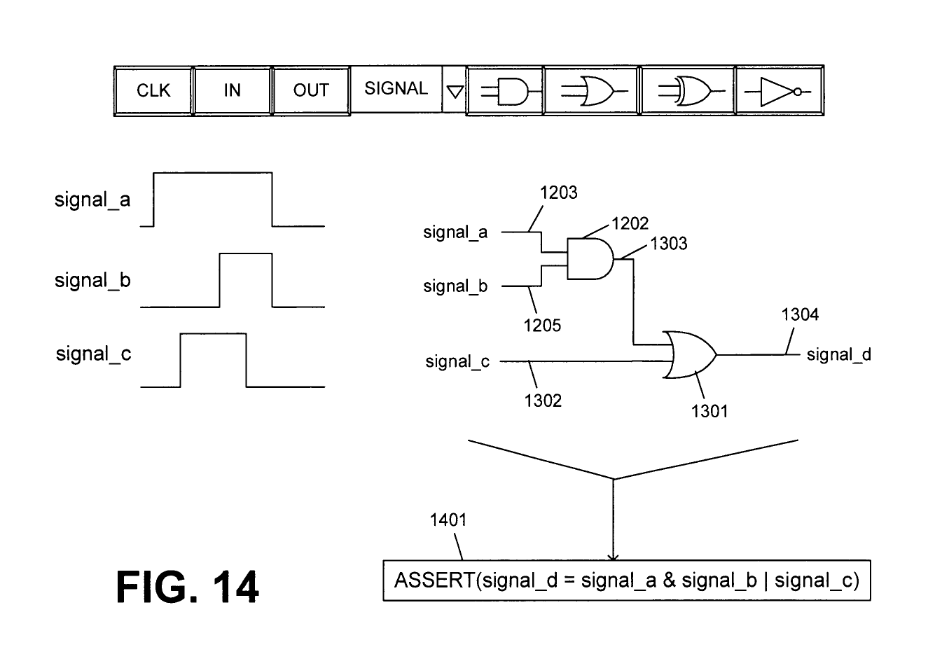

After one or more combinatorial relationships are created using the procedure illustrated in FIGS. 10-13, the user instructs the program to map the relationships in the diagram to assertions. The result is shown in FIG. 14. The method produces assertion 1401 from the information provided by nodes 1203, 1205, 1302, 1303, 1304 and relationship symbols 1202 and 1301. In the SystemVerilog language, the assertion generated is: ASSERT(signal_d=signal_& signal_b OR|signal_c). In one embodiment, the assertion mapping instruction is given via a menu item (not shown). In another embodiment, the assertion mapping instruction is given via a pushbutton (not shown). In one embodiment, the user specifies a default assertion language through a dialog box, and the default can be overridden via a specific language selection at the time the mapping instruction is given. In another embodiment, the user must specify a specific assertion language when giving the mapping instruction.

One embodiment of the method for generating assertions using waveforms identifies combinatorial relationships that aren't explicitly defined by a relationship symbol. The inputs and outputs of a waveform can be analyzed using existing techniques, such as truth tables and Karnaugh maps, to derive combinatorial relationships between signals. This embodiment generates assertions for combinatorial relationships that are identified in this manner, as well as for relationships that are explicitly defined by a symbol.

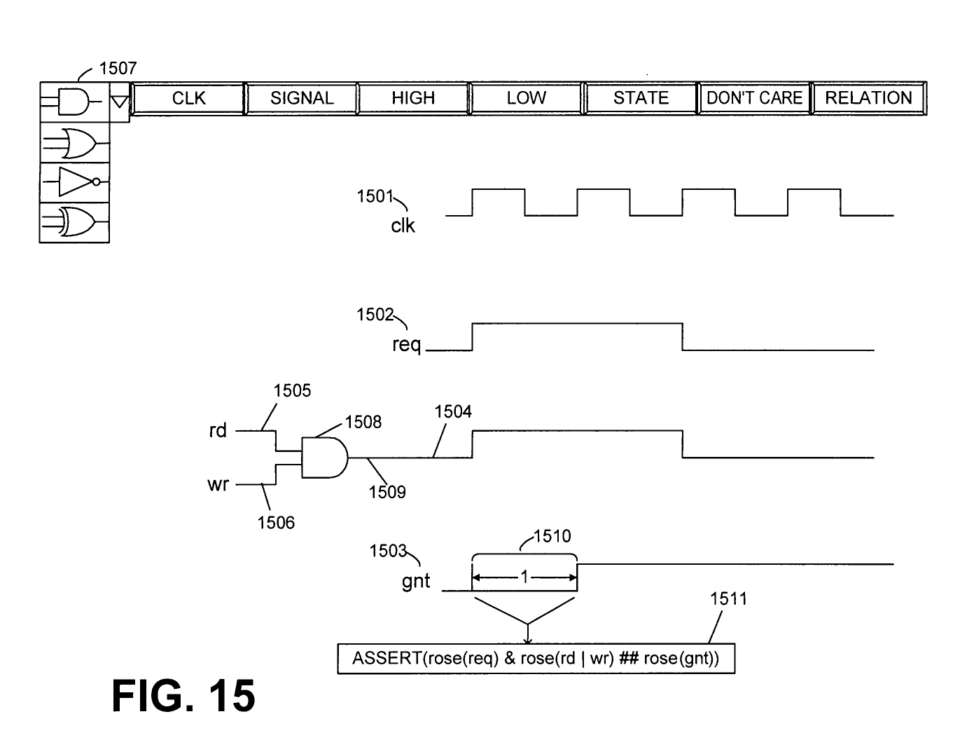

FIG. 15 illustrates another embodiment of the method which allows a combination of timing and combinatorial relationships to be defined. As with the other embodiments, assertions are then generated from the relationships. The waveform diagram of this example has clock signal 1501, req signal 1502, gnt signal 1503, and an additional signal 1504. In this embodiment, the waveform is produced using the process described in FIGS. 5-8.

Then input signals rd 1505 and wr 1506 are defined and a combinatorial relationship is defined using those two signals as input. In this embodiment, a process like the one described in connection with FIGS. 10-13 is used, but a dropdown control 1507 is used for the combinatorial operator 1508 instead of separate buttons. The combinatorial output 1509 is connected to the waveform diagram signal 1504.

Next, timing relationship indicator 1510 is added, using the process described in connection with FIGS. 1-3. Finally, the user instructs the program to map the relationships in the diagram to assertions. In this example, the method produces assertion 1511 from the information provided by timing relationship indicator 1510. Assertion 1511 includes both a timing and a combinatorial relationship:

ASSERT(rose(req) & rose(rd|wr) ## rose(gnt)).

Many variations on the user interfaces illustrated in FIGS. 1-15 are possible. In the example, the click position indicates only time, and the high/low signal value is determined by the state (enabled/disabled) of pushbutton controls high 604 and low 605. In another embodiment, the click position indicates both time and signal value, so that the user indicates a high signal value by clicking above the zero line, and a low signal value by clicking near the zero line. In yet another embodiment, a text-based interface is used instead of a graphical interface. In this text-based embodiment, a user can enter text from the command line, or from a file. A signal can be described in text by a series of time/value pairs. Using one example of such a notation, a signal which starts high on the first clock, goes low on the second clock, stays low for two clocks, and then goes high can be described as: (0,1) (1,0) (2,0) (3,1). Signal relationships can also be described textually.

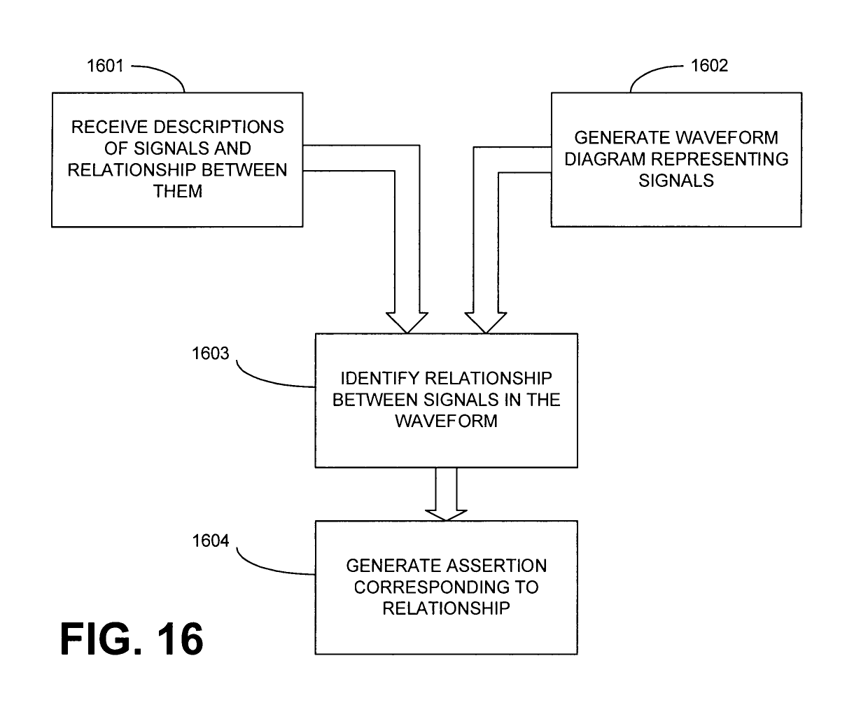

FIG. 16 is a flow chart of the method for generating assertions using waveforms. In step 1601, the method receives descriptions of signals and the relationship(s) between the signals. In step 1602, the method generates a waveform representing the signals and the relationship(s). Steps 1601 and 1602 are optional, since the method may operate on waveforms and/or descriptions that are provided by another means or program. In step 1603, the waveform is analyzed to identify one or more relationships between signals. If step 1601 was performed by the method, the signal descriptions and relationship descriptions may be used in the analysis. In the final step, step 1604, the method generates one or more assertions corresponding to the identified relationships.

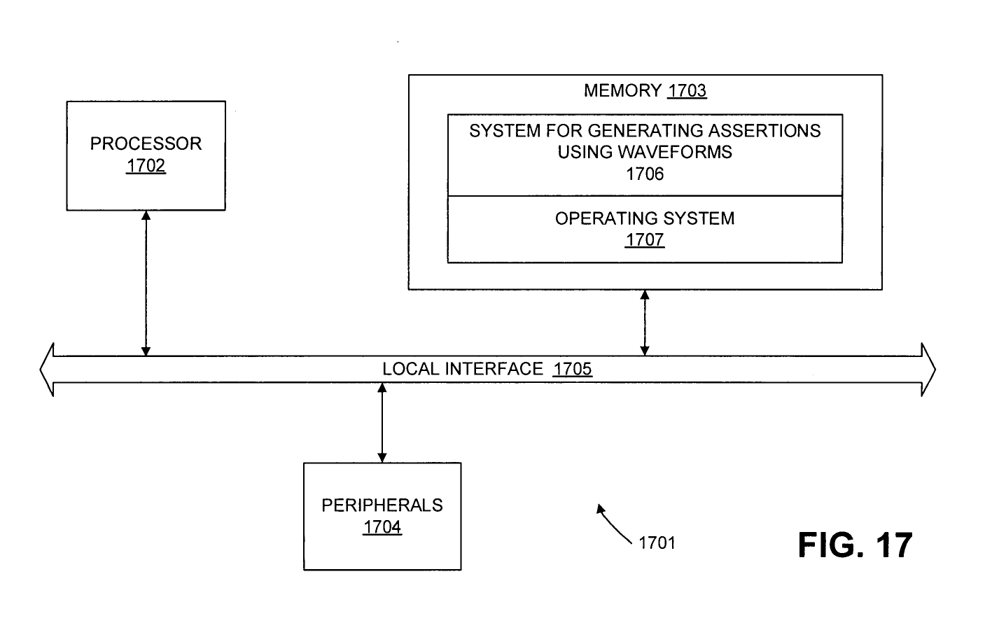

FIG. 17 is a block diagram of a general-purpose computer system that can be used to implement an embodiment of the method for generating assertions using waveforms. One skilled in the art will realize that the method can execute on the same system that executes the other IC design tools (editor, synthesizer, compiler, simulator, debugger, etc.), or it can execute remotely on a server system (e.g., in an X-Windows environment). Generally, in terms of hardware architecture, the computer 1701 includes a processor 1702, memory 1703, and one or more input or output (I/O) devices or peripherals 1704 that are communicatively coupled via a local interface 1705. The local interface 1705 can be, for example but not limited to, one or more buses or other wired or wireless connections, as is known in the art. The local interface 1705 may have additional elements (omitted for simplicity), such as controllers, buffers, drivers, repeaters, and receivers, to enable communications. Further, the local interface 1705 may include address, control, and data connections to enable appropriate communications among the aforementioned components.

The processor 1702 is a hardware device for executing software, particularly that stored in memory 1703. The processor 1702 can be any custom made or commercially available processor, a central processing unit (CPU), an auxiliary processor among several processors associated with the computer 1701, a semiconductor based microprocessor (in the form of a microchip or chip set), a microprocessor, or generally any device for executing software instructions.

The memory 1703 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 1703 may incorporate electronic, magnetic, optical, or other types of storage media. Note that the memory 1703 can have a distributed architecture, where various components are situated remote from one another, but can be accessed by the processor 1702.

The software in memory 1703 may include one or more separate programs, each of which comprises an ordered listing of executable instructions for implementing logical functions. In this example embodiment, software in memory 1703 includes one or more components of the system for generating assertions using waveforms 1706, and a suitable operating system 1707. The operating system 1707 essentially controls the execution of other computer programs, such as the method for merging assertions with an HDL source file, and provides scheduling, input-output control, file and data management, memory management, and communication control and related services.

The method is a source program, executable program (object code), script, or any other entity comprising a set of instructions to be performed. When a source program, then the program needs to be translated via a compiler, assembler, interpreter, or the like, which may or may not be included within memory 1703, so as to operate properly in connection with the operating system 1707.

The peripherals 1704 may include input devices, for example but not limited to, a keyboard, mouse, scanner, microphone, etc. Furthermore, the peripherals 1704 may also include output devices, for example but not limited to, a printer, display, facsimile device, etc. Finally, the peripherals 1704 may further include devices that communicate both inputs and outputs, for instance but not limited to, a modulator/demodulator (modem; for accessing another device, system, or network), a radio frequency (RF) or other transceiver, a telephone interface, a bridge, a router, etc.

If the computer 1701 is a PC, workstation, or the like, the software in the memory 1703 may further include a basic input output system (BIOS). The BIOS is a set of essential software routines that initialize and test hardware at startup, start the operating system 1707, and support the transfer of data among the hardware devices. The BIOS is stored in the ROM so that the BIOS can be executed when the computer 1701 is activated.

When the computer 1701 is in operation, the processor 1702 is configured to execute software stored within the memory 1703, to communicate data to and from the memory 1703, and to generally control operations of the computer 1701 in accordance with the software. The system for generating assertions using waveforms 1706 and the operating system 1707, in whole or in part, but typically the latter, are read by the processor 1702, and perhaps buffered within the processor 1702, and then executed.

It should be noted that the method can be stored on any method for use by or in connection with any computer related system or method. In the context of this document, a “computer-readable medium” can be any means that can store, communicate, propagate, or transport the program for use by or in connection with the instruction execution system, system, or device. The computer-readable medium can be, for example but not limited to, an electronic, magnetic, optical, electromagnetic, infrared, or semiconductor system, system, device, or propagation medium. A non-exhaustive example set of the computer-readable medium would include the following: an electrical connection having one or more wires, a portable computer diskette, a random access memory (RAM), a read-only memory (ROM), an erasable programmable read-only memory (EPROM, EEPROM, or Flash memory), and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the method is implemented in hardware, it can be implemented with any or a combination of the following technologies, which are each well known in the art: a discrete logic circuit(s) having logic gates for implementing logic functions upon data signals, an application specific integrated circuit(s) (ASIC) having appropriate combinatorial logic gates, a programmable gate array(s) (PGA), a field programmable gate array(s) (FPGA), etc.

The foregoing description has been presented for purposes of illustration and description. It is not intended to be exhaustive or to limit the invention to the precise forms disclosed. Obvious modifications or variations are possible in light of the above teachings. The embodiments discussed, however, were chosen and described to illustrate the principles of the invention and its practical application to thereby enable one of ordinary skill in the art to utilize the invention in various embodiments and with various modifications as are suited to the particular use contemplated. All such modifications and variation are within the scope of the invention as determined by the appended claims when interpreted in accordance with the breadth to which they are fairly and legally entitled.

1. A method for generating a Hardware Design Language (HDL) assertion from a waveform diagram, the waveform diagram comprising a first signal, a second signal, and a clock signal, the method comprising the steps of:
identifying a timing relationship between the first and the second signal, the timing relationship comprising a portion of the first signal, a portion of the second signal, and an interval period between the portion of the first signal and the portion of the second signal; and
generating an HDL assertion corresponding to the timing relationship.

2. The method of claim 1, wherein the portion of the first signal includes a signal transition.

3. The method of claim 2, wherein the signal transition is substantially coincident with an edge of the clock signal.

4. The method of claim 2, wherein the signal transition occurs within a period of the clock signal.

5. The method of claim 1, wherein the portion of the first signal includes a signal state.

6. The method of claim 5, wherein the signal state is logic low or logic high.

7. The method of claim 1, further comprising the step of:
receiving an indication of the timing relationship, wherein the indication identifies the portion of the first signal, the portion of the second signal, and the interval period.

8. The method of claim 7, the receiving step further comprising:
receiving an indication of the timing relationship, wherein a first edge of the indication aligns with the portion of the first signal and a second edge of the indication aligns with the portion of the second signal.

9. The method of claim 7, the receiving step further comprising:
receiving an indication of the timing relationship, wherein the indication specifies a numeric value for the interval period.

10. The method of claim 7, the receiving step further comprising:
receiving an indication of the timing relationship, wherein the indication specifies a range for the interval period.

11. The method of claim 1, the generating step further comprising:
determining that the relationship includes a signal transition; and
responsive to determination of a signal transition, generating an HDL assertion including a signal transition.

12. The method of claim 1, the generating step further comprising:
determining that the relationship includes a signal state; and
responsive to determination of a signal transition, generating an HDL assertion including a signal state.

13. The method of claim 1, further comprising the step of:
identifying a combinatorial relationship between a first and a second input signal and a combinatorial output signal; and
identifying a timing relationship between the combinatorial output signal and a follower signal, the timing relationship comprising a segment of the combinatorial signal, a segment of the follower signal, and an interval period between the segment of the first signal and the segment of the second signal.

14. A method having a computer program for generating a Hardware Design Language (HDL) assertion from a waveform diagram, the waveform diagram comprising a first input signal, a second input signal, and an output signal, the program comprising the steps of:
identifying a combinatorial relationship between the first and second input signals and the output signal; and
generating an HDL assertion corresponding to the relationship.

15. The method of claim 14, further comprising the step of:
receiving an indication of the combinatorial relationship, wherein the indication identifies a connection between the first and second input signals, a boolean operator, and the output signal.

16. A computer readable medium for generating a Hardware Design Language (HDL) assertion from a waveform diagram, the waveform diagram comprising a plurality of signals, the program comprising logic for performing the steps of:
receiving a plurality of signal descriptions, each of the plurality of signal descriptions describing one of the plurality of signals;
receiving a signal relationship description describing a timing or combinatorial relationship between at least two of the plurality of signals;
generating the waveform diagram including a representation of the relationship; and
generating an HDL assertion corresponding to the relationship.

17. The computer readable medium of claim 16, the program further comprising logic for performing the step of:
providing a first user interface control corresponding to one of the signal descriptions.

18. The computer readable medium of claim 16, the program further comprising logic for performing the step of:
providing a second user interface control corresponding to the signal relationship description.

19. The computer readable medium of claim 16, the program further comprising logic for performing the step of:
providing a second user interface control corresponding to the signal relationship description, the second user interface control allowing the indication of a portion of the first signal, the indication of a portion of the second signal, and the indication of an interval period between the portion of the first signal and the portion of the second signal.

20. The computer readable medium of claim 16, the program further comprising logic for performing the step of:
providing a second user interface control corresponding to the signal relationship description, the second user interface control allowing the indication of a connection between at least two of the plurality of signals, a boolean operator, and an output signal.
